(19) United States
(12) Patent Application Publication
(10) Pub. No.: US 2012/0082142 A1
(43) Pub. Date: Apr. 5, 2012

(54) METHOD OF ALLOCATING RADIO RESOURCE AND TRANSMITTING DATA

(75) Inventors: Yong Sun KIM, Daejeon (KR); Seung Eun HONG, Daejeon (KR); Woo Yong LEE, Daejeon (KR); Hyun Kyu CHUNG, Daejeon (KR)

(73) Assignee: ELECTRONICS AND TELECOMMUNICATIONS RESEARCH INSTITUTE, Daejeon (KR)

(21) Appl. No.: 13/253,371

(22) Filed: Oct. 5, 2011

(30) Foreign Application Priority Data
Oct. 5, 2010 (KR) 10-2010-0096649
Aug. 24, 2011 (KR) 10-2011-0084409

(51) Int. Cl. H04J 3/00

(52) U.S. Cl. 370/336

(57) ABSTRACT

Provided is a data transmission method. The data transmission method may limit a use authorization for a contention time period so that a portion of data transmission devices among a plurality of data transmission devices may transmit data during the contention time period.

### CROSS-REFERENCE TO RELATED APPLICATIONS

This application claims the benefit of Korean Patent Applications No. 10-2010-0096649, filed on Oct. 5, 2010 and No. 10-2011-0084409, filed on Aug. 24, 2011, in the Korean Intellectual Property Office, the disclosures of which are incorporated herein by reference.

### BACKGROUND

1. Field of the Invention

The present invention relates to a method of transmitting data in a wireless local area network (WLAN) or wireless personal area network (WPAN) environment, and more particularly, to a method of allocating a radio resource for preventing a collision of data transmitted by a plurality of data transmission devices, and to a method of transmitting data using the allocated radio resource.

2. Description of the Related Art

A conventional network such as a wireless local area network (WLAN) or a wireless personal area network (WPAN) may allocate a predetermined radio resource to a predetermined data transmission device, or may use a contention based transmission scheme in which a predetermined data transmission device transmits data without sharing a predetermined radio resource.

In the contention based transmission scheme, a plurality of data transmission devices may share a radio resource, and a data transmission device having data to be transmitted may transmit the data using the radio resource. In this instance, when the plurality of data transmission devices transmits data using the same radio resource, a data reception device may not receive data from any of the plurality of data transmission devices, which may correspond to a collision of data transmitted by each data transmission device. The collision may be an issue to be prevented in the contention based transmission scheme.

### SUMMARY

An aspect of the present invention provides a method of allocating a resource that may reduce a data collision among a plurality of data transmission devices in a contention time period.

Another aspect of the present invention also provides a method of transmitting data that may enhance a possibility of succeeding in transmitting data.

According to an aspect of the present invention, there is provided a method of transmitting data, the method including setting an order of priority for a contention time period, receiving, from a resource allocation device, a use authorization for the contention time period, determining whether to use the contention time period by comparing the order of priority and the use authorization, and transmitting data to a data reception device during the contention time period based on the determination.

According to another aspect of the present invention, there is provided a method of allocating a resource, the method including determining a contention time period, setting a use authorization for the determined contention time period, and transmitting the use authorization to a plurality of data transmission devices in which an order of priority for the contention time period is set, wherein the use authorization is compared to the order of priority of each of the plurality of data transmission devices, and the plurality of data transmission devices transmits data to a data reception terminal during the contention time period based on a result of the comparison.

According to still another aspect of the present invention, there is provided a method of receiving data, the method including comparing a use authorization set for a contention time period and an order of priority set for a data transmission device, and receiving transmitted data according to a result of the comparison from the data transmission device during the contention time period.

According embodiments of the present invention, it is possible to reduce a data collision among a plurality of data transmission devices in a contention time period.

According embodiments of the present invention, it is possible to enhance a possibility of succeeding in transmitting data.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a method of transmitting data according to embodiments of the present invention;

FIG. 2 is a flowchart illustrating a method of transmitting data according to embodiments of the present invention;

FIG. 3 is a diagram illustrating a beacon interval structure according to embodiments of the present invention;

FIG. 4 is a diagram illustrating a scheduling information element according to embodiments of the present invention;

FIG. 5 is a diagram illustrating an allocation of a contention time period according to embodiments of the present invention;

FIG. 6 is a diagram illustrating a traffic mapping according to embodiments of the present invention;

FIG. 7 is a flowchart illustrating a method of transmitting data according to embodiments of the present invention;

FIG. 8 is a flowchart illustrating a method of allocating a resource according to embodiments of the present invention; and

FIG. 9 is a flowchart illustrating a method of receiving data according to embodiments of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

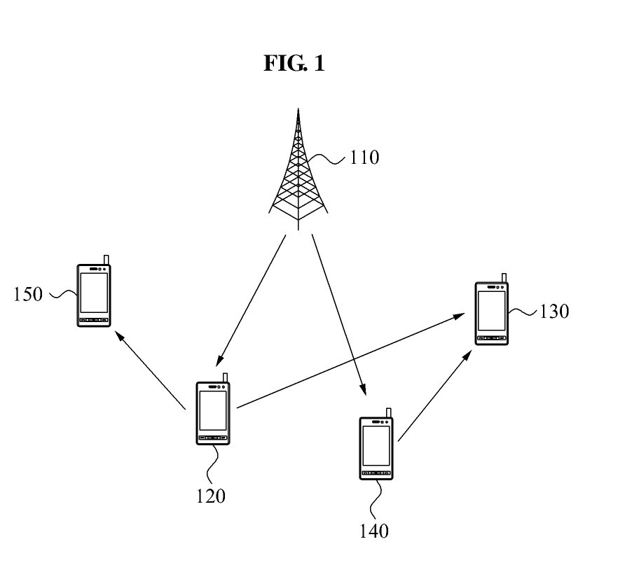

FIG. 1 is a diagram illustrating a method of transmitting data according to embodiments of the present invention.

A resource allocation device 110 may allocate a predetermined radio resource to each of data transmission devices 120 and 140 so that each of the data transmission devices 120 and 140 may transmit data. Hereinafter, the data transmission device 120 may be referred to as a first data transmission device 120, and the data transmission device 140 may be referred to as a second data transmission device 140 for convenience of description. In response to a predetermined radio resource allocated to a predetermined data transmission device, for example, the first data transmission device 120 or the second data transmission device 140, the predetermined data transmission device may transmit data using the allocated radio resource. Thus, a collision may not occur between data transmitted by the first data transmission device 120 and data transmitted by the second data transmission device 140. Herein, the transmission of data using an allocated radio resource may refer to as a non-contention based data transmission.

According embodiments of the present invention, the resource allocation device 110 may allocate a common radio resource that may be used for the data transmission devices 120 and 140 to transmit data. When each of the data transmission devices 120 and 140 has data to be transmitted, each of the data transmission devices 120 and 140 may transmit the data using the common radio resource.

In the contention based data transmission, when a single data transmission device transmits data, the data may be transmitted successfully. However, when a plurality of data transmission devices, for example, the data transmission devices 120 and 140 transmit data, a data collision may occur, and a data reception device 130 may be unsuccessful in receiving any data.

To prevent the data collision, each of the data transmission devices 120 and 140 may wait during a predetermined period of time, within a time period for transmitting data. The first data transmission device 120 may verify whether the second data transmission device 140 transmits data for the predetermined period of time. When the first data transmission device 120 fails to receive data from the second data transmission device 140 during the predetermined period of time, the first data transmission device 120 may determine the second data transmission device 140 does not transmit data during the period of time for transmitting data, and may transmit data of the first data transmission device 120. As such, a collision of data transmitted by each of the data transmission devices 120 and 140 may be significantly reduced.

According embodiments of the present invention, each of the data transmission devices 120 and 140 may transmit and receive data using an array antenna or a directional antenna including a plurality of antennas. In this instance, the data transmission devices 120 and 140 may transmit data in a predetermined direction, or receive data from a predetermined direction.

FIG. 1 illustrates that the second data transmission device 140 includes an array antenna. Data transmitted by the second data transmission device 140 may be transmitted to a first data reception device 150 and the second data reception device 130. The second data transmission device 140 may concentrate a transmission of data in a direction of the second data reception device 130 and thus, may not receive data transmitted from the first data transmission device 120. Thus, the second data transmission device 140 may not verify whether the first data transmission device 120 transmits data, and may transmit data to the second data reception device 130 using the same radio resource as the first data transmission device 120. In this instance, the second data reception device 130 may receive data from neither the first data transmission device 120 nor the second data transmission device 140.

According embodiments of the present invention, the resource allocation device 110 may set a use authorization for a radio resource. The resource allocation device 110 may transmit the set use authorization to each of the data transmission devices 120 and 140. Each of the data transmission devices 120 and 140 may set an order of priority for a radio resource. That is, the order of priority may be individually set for each of the data transmission devices 120 and 140 and thus, the first data transmission device 120 may have a relatively high order of priority, and the second data transmission device 140 may have a relatively low order of priority. Each of the data transmission devices 120 and 140 may compare a set use authorization and an order of priority of each of the data transmission devices 120 and 140 for a radio resource.

When an order of priority of each of the data transmission devices 120 and 140 exceeds a set use authorization, each of the data transmission devices 120 and 140 may transmit data using the corresponding radio resource. When an order of priority of the first data transmission device 120 exceeds a use authorization set for a radio resource, and an order of priority of the second data transmission device 140 is less than a use authorization set for the radio resource, the first data transmission device 120 may transmit data.

A portion of data transmission devices may transmit data based on a result of comparing an order of priority of each of the data transmission devices 120 and 140 and a use authorization set for a radio resource. Accordingly, a possibility of a collision of data transmitted by data transmission devices may be significantly reduced.

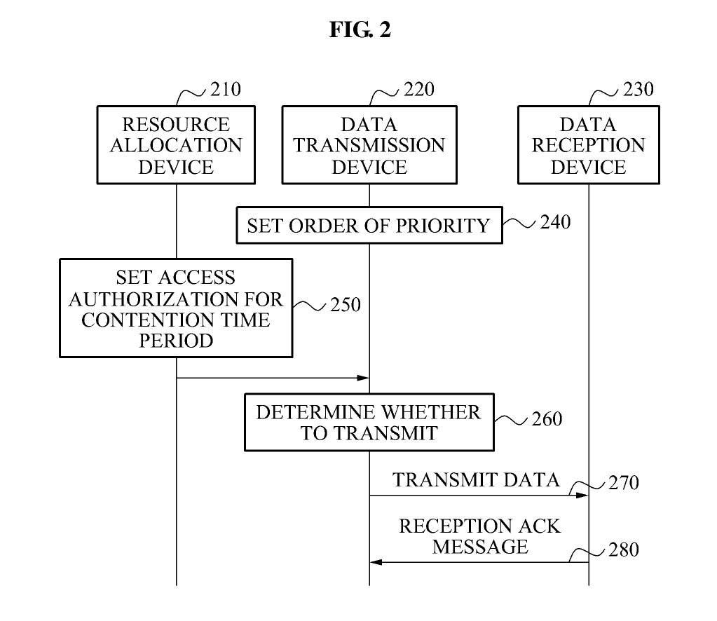

FIG. 2 is a flowchart illustrating a method of transmitting data according to embodiments of the present invention.

In operation 240, a data transmission device 220 sets an order of priority for a common radio resource. According embodiments of the present invention, the data transmission device 220 may set the order of priority based on a characteristic of data to be transmitted by the data transmission device 220. For example, when the data to be transmitted corresponds to audio data, the data transmission device 220 may set a relatively high order of priority. When the data to be transmitted does not correspond to audio data, the data transmission device 220 may set a relatively low order of priority.

In operation 250, a resource allocation device 210 may set an order of priority for a contention time period. According to embodiments of the present invention, the resource allocation device 210 may set a use authorization for the contention time period based on a number of data transmission devices desiring to use the contention time period. For example, when the number of data transmission devices desiring to use the contention time period is relatively great, the resource allocation device 210 may set a use authorization for the contention time period to a relatively high value. The resource allocation device 210 may transmit the use authorization for the contention time period to the data transmission device 220.

In operation 260, the data transmission device 220 may determine whether to use the contention time period by comparing the order of priority for the contention time period and the use authorization of the data transmission device 220. In this instance, using the contention time period may correspond to transmitting data by the data transmission device 220 to a data reception device 230.

When the contention time period is determined to be used in operation 260, the data transmission device 220 may transmit data to the data reception device 230 in operation 270.

When a single data transmission device, for example, the data transmission device 220 transmits data in operation 270, the data reception device 230 may succeed in receiving data, and transmit a reception acknowledgement (ACK) message to the data transmission device 220 in operation 280.

However, when a plurality of data transmission devices, including the data transmission device 220, transmits data in operation 270, the data reception device 230 may fail to receive data from any of the plurality of data transmission devices since data transmitted by each of the plurality of data transmission devices may collide. Thus, the data reception device 230 may not transmit the reception ACK message.

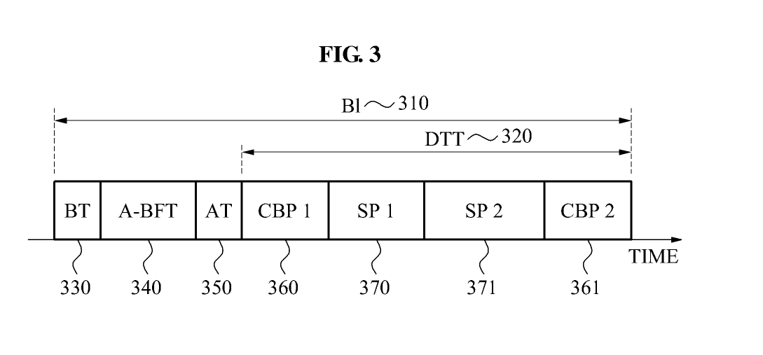

FIG. 3 is a diagram illustrating a beacon interval structure according to embodiments of the present invention.

A beacon interval (BI) 310 may include a beacon time (BT) 330, an associated beamforming training (A-BFT) 340, an announcement time (AT) 350, and a data transfer time (DTT) 320. The BT 330, the A-BFT 340, the AT 350, and the like correspond to time periods for transmitting control information, for transmitting data, and the DTT 320 corresponds to a time period for transmitting data.

According to embodiments of the present invention, the DTT 320 may include contention-based periods (CBP1 and CBP2) 360 and 361, and service periods (SP1 and SP2) 370 and 371. The CBP1 and the CBP2 each correspond to a time period during which each data transmission device transmits data in a contention-based transmission scheme, and hereinafter is referred to as a contention time period for conciseness in this specification. The SP1 and the SP2 each correspond to a time period during which each data transmission device transmits data using a radio resource uniquely allocated to each data transmission device.

Referring to FIG. 3, the CBP1 360 and the CBP2 361 may be allocated within a single BI 310. When a plurality of data transmission devices transmits data during the CBP1 360 and the CBP2 361, a data collision may be likely to occur during the CBP1 360 and the CBP2 361.

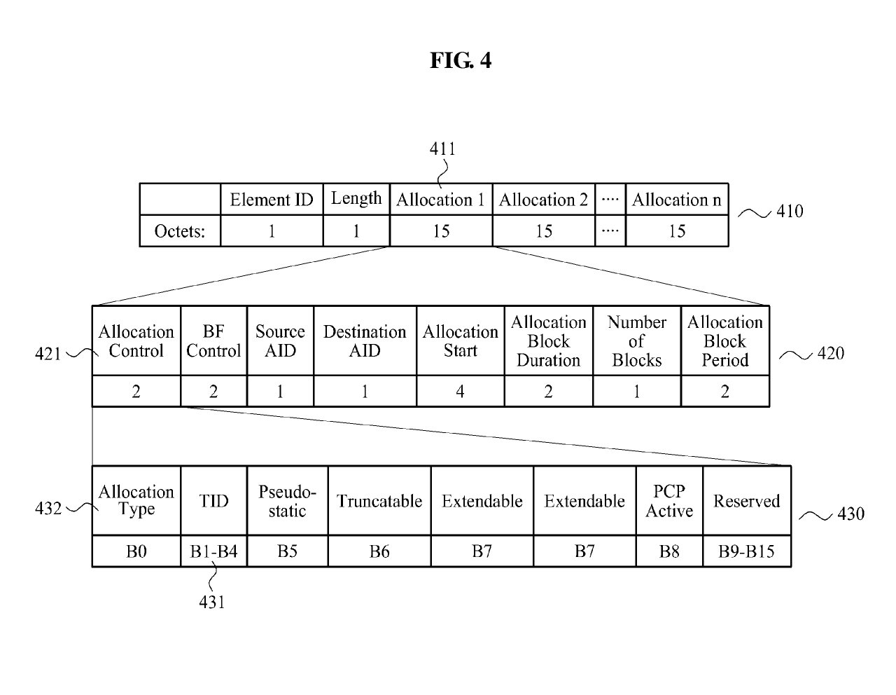

FIG. 4 is a diagram illustrating a scheduling information element according to embodiments of the present invention. As described in the foregoing, to reduce a possibility of a data collision in a contention time period, a portion of data transmission devices among a plurality of data transmission devices may transmit data in the contention time period.

According to embodiments of the present invention, a resource allocation device may allow a portion of data transmission devices to use a contention time period by setting a use authorization for each contention time period.

The resource allocation device may use scheduling information 410 illustrated in FIG. 4 to transmit, to a data transmission device, information regarding whether a contention time period is set within a BI and a use authorization for the set contention time period.

The scheduling information 410 may include an allocation information element 411. An allocation information element 420 further illustrates the allocation information element 411 included in the scheduling information 410. The allocation information element 420 may include allocation control information 421. Allocation control information 430 further illustrates the allocation control information 421 included in the allocation information element 420. The allocation control information 430 may include traffic identification (TID) information 431.

Referring to FIG. 4, in response to allocation type information being set to “0,” the corresponding scheduling period may set to a non-contention time period, and a predetermined radio resource may be allocated to each data transmission device. A data transmission device may transmit data without a collision using an allocated radio resource. In this instance, a traffic category value or a traffic stream value may be allocated to the TID information 431, and data transmitted by each data transmission device may be identified using the TID information 431.

According to embodiments of the present invention, in response to allocation type information being set to “1,” the corresponding scheduling period may be set to a contention time period. In this instance, the resource allocation device may transmit the use authorization for the contention time period to a data transmission device using the TID information 431.

As an example, when the use authorization for the contention time period transmitted using the TID information 431 corresponds to “0,” all data transmission devices may transmit data during the contention time period.

When the use authorization for the contention time period transmitted using the TID information 431 corresponds to “1,” a data transmission device having an order of priority greater than or equal to “1” may transmit data during the contention time period.

When the use authorization for the contention time period transmitted using the TID information 431 corresponds to “2,” a data transmission device having an order of priority greater than or equal to “2” may transmit data during the contention time period.

When the use authorization for the contention time period transmitted using the TID information 431 corresponds to “3,” a data transmission device having an order of priority greater than or equal to “3” may transmit data during the contention time period.

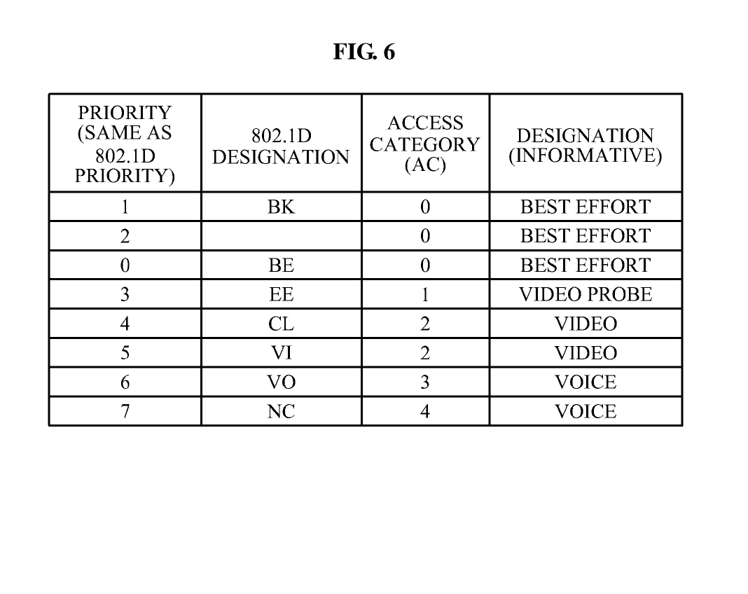

According to embodiments of the present invention, an order of priority of each data transmission device may denote an access category, and an order of priority of a data transmission device may correspond to a value classified based on a traffic type, that is, a characteristic of data transmitted by each data transmission device, presented by QoS MAC of IEEE 802.11e. The traffic type based on a characteristic of data transmitted by each data transmission device will be further described with reference to FIG. 6.

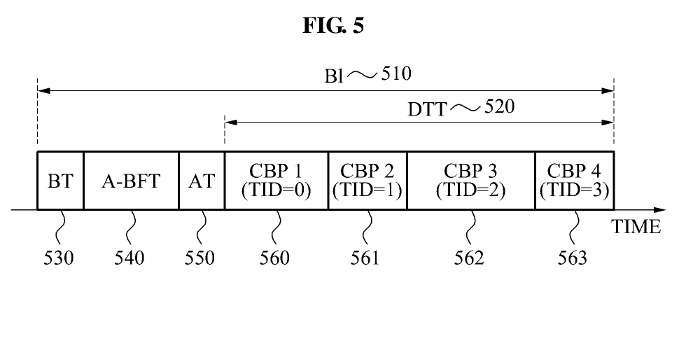

FIG. 5 is a diagram illustrating an allocation of a contention time period according to embodiments of the present invention.

Since a BI 510, a DTT 520, a BT 530, an A-BFT 540, an AT 550, and the like of FIG. 5 are similar to the BI 310, the DTT 320, the BT 330, the A-BFT 340, the AT 350, and the like of FIG. 3, further description will be omitted for conciseness.

Referring to FIG. 5, four contention time periods 560, 561, 562, and 563 are set in a DTT 520. Hereinafter, the contention time periods 560, 561, 562, and 563 may be referred to as a first contention time period 560, a second contention time period 561, a third contention time period 562, and a fourth contention time period 563, respectively for convenience of description. A TID value in each of the contention time periods 560, 561, 562, and 563 indicates a use authorization of each of the contention time periods 560, 561, 562, and 563.

Since a use authorization of the first contention time period 560 corresponds to “0,” all data transmission devices may transmit data using the first contention time period 560. Thus, a possibility of a data collision may be relatively high.

Since a use authorization of the second contention time period 561 corresponds to “1,” a data transmission device having an order of priority greater than or equal to “1” may transmit data using the second contention time period 561. Thus, a possibility of a data collision may be slightly reduced.

Since a use authorization of the third contention time period 562 corresponds to “2,” a data transmission device having an order of priority greater than or equal to “2” may transmit data using the third contention time period 562. Thus, a possibility of a data collision may be considerably reduced.

Since a use authorization of the fourth contention time period 563 corresponds to “3,” a data transmission device having an order of priority greater than or equal to “3” may transmit data using the fourth contention time period 563. Thus, a possibility of a data collision may be significantly reduced.

FIG. 6 is a diagram illustrating a traffic mapping according to embodiments of the present invention.

When data transferred from a higher level is transmitted using a contention time period, a data transmission device may map each data element to the corresponding access category with reference to FIG. 6. Referring to FIG. 6, a value of an access category may be determined as a priority of each data transmission device.

Referring to FIG. 6, when data corresponds to a video probe, the data may be mapped to an access category AC [1], and a priority of a data transmission device may correspond to “1.”

When data corresponds to a video, the data may be mapped to an access category AC [2], and a priority of a data transmission device may correspond to “2.”

When data corresponds to a voice, the data may be mapped to an access category AC [3], and a priority of a data transmission device may correspond to “3.”

A resource allocation device may set a use authorization for a contention time period, and each data transmission device may compare the use authorization and an order of priority of each data transmission device, and may use a contention time period. Since a portion of data transmission devices among all data transmission devices may use a contention time period, a number of data transmission devices using the contention time period may be reduced. Thus, a possibility of a data collision may decrease in a contention based transmission scheme.

As illustrated in FIG. 6, when a priority is determined based on a characteristic of data, a data transmission device transmitting audio data may set a highest priority for audio data. Thus, a possibility of failing to transmit the audio data may be significantly reduced.

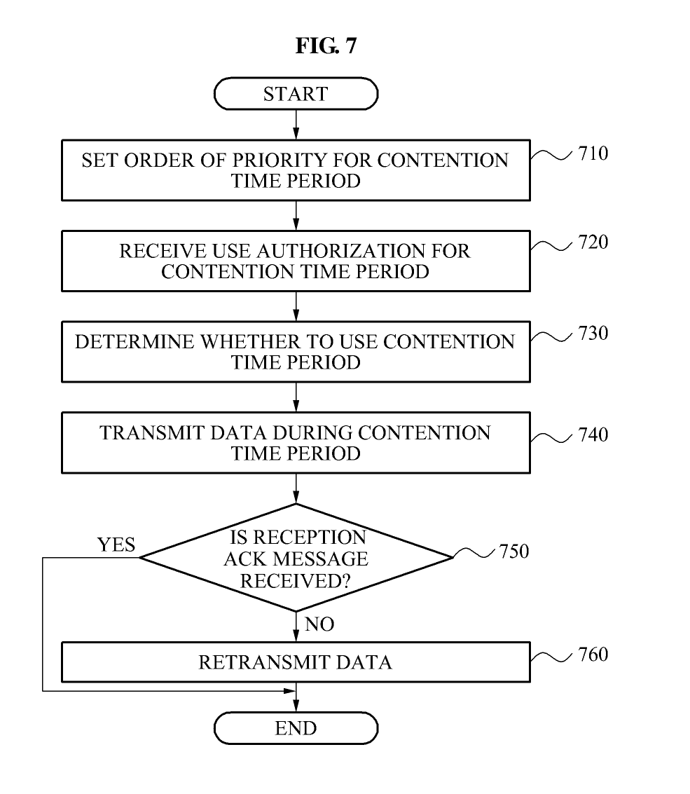

FIG. 7 is a flowchart illustrating a method of transmitting data according to embodiments of the present invention.

In operation 710, a data transmission device may set an order of priority for a contention time period. According to embodiments of the present invention, the data transmission device may set the order of priority for the contention time period based on a characteristic or a traffic type of data to be transmitted by the data transmission device in a contention based transmission scheme during the contention time period.

For example, when the data to be transmitted by the data transmission device corresponds to audio data, the data transmission device may set a relatively high order of priority for the contention time period. When the data to be transmitted by the data transmission device does not correspond to audio data, and corresponds to video data, a downloaded file, and the like, the data transmission device may set a relatively low order of priority for the contention time period.

The data transmission device may set a relatively high order of priority for the contention time period when data to be transmitted is responsive to a time delay, and may set a relatively low order of priority for the contention time period when data to be transmitted is less responsive to a time delay.

FIG. 7 illustrates an example of setting an order of priority based on a characteristic of data by the data transmission device. According to another example, a resource allocation device may determine an order of priority of the data transmission device, and transmit the determined order of priority to the data transmission device. The data transmission device may set an order of priority for a contention time period based on the received order of priority.

In operation 720, the data transmission device may receive, from the resource allocation device, a use authorization for the contention time period. The use authorization for the contention time period may correspond to a value set by the resource allocation device to limit a number of data transmission devices using the contention time period.

In operation 730, the data transmission device may determine whether to transmit data to a data reception device during the contention time period with reference to the use authorization for the contention time period. According to embodiments of the present invention, the data transmission device may compare the order of priority for the contention time period and the use authorization for the contention time period, and may determine whether to transmit data to the data reception device based on a result of the comparison. For example, the data transmission device may determine to transmit data using the contention time period when the order of priority for the contention time period is greater than or equal to the use authorization for the contention time period.

In operation 740, the data transmission device may transmit data to the data reception device during the contention time period according to a determination in operation 730. For example, the data transmission device may wait during a predetermined period of time from a starting time of the contention time period. When the data transmission device receives second data transmitted by another data transmission device during a predetermined period of time, the data transmission device may determine that another data transmission device transmits data during the contention time period, and may cancel the transmitting of data of the data transmission device.

When the data transmission device does not receive second data transmitted by another data transmission device during a predetermined period of time, the data transmission device may transmit data to the data reception device during the contention time period.

The data reception device may receive data from the data transmission device, and may transmit, to the data transmission device, a reception acknowledgement (ACK) message for the received data.

In operation 750, the data transmission device may determine whether the reception ACK message is received from the data reception device. When a single data transmission device transmits data, the data reception device may succeed in receiving the data, and may transmit a reception ACK message to the data transmission device. In this instance, the data transmission device may terminate transmitting data.

When each of a plurality of data transmission devices transmits data to the data reception device, a data collision may occur. Thus, the data reception device may fail to receive any data. When data fails to be transmitted, the data reception device may not transmit a reception ACK message for the data to the data transmission device. In this instance, the data transmission device may determine the reception ACK message is not received in operation 750. When the reception ACK message is not received, the data transmission device may retransmit the data to the data reception device in operation 760.

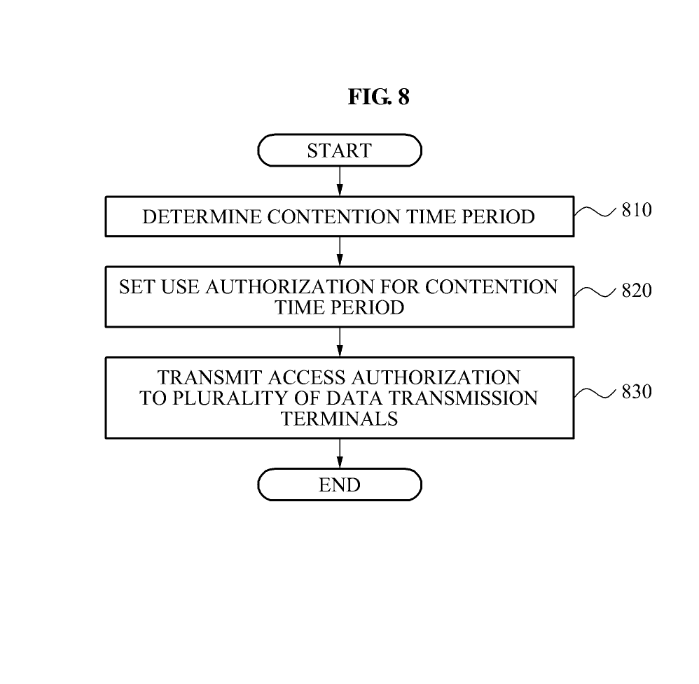

FIG. 8 is a flowchart illustrating a method of allocating a resource according to embodiments of the present invention.

In operation 810, a resource allocation device may determine a contention time period. According to embodiments of the present invention, as illustrated in FIG. 5, the resource allocation device may determine a plurality of contention time periods within the DTT 520 included in the BI 510.

In operation 820, the resource allocation device may set a use authorization for the determined plurality of contention time periods. According to embodiments of the present invention, the resource allocation device may set the use authorization based on a number of data transmission devices that receive the use authorization from the resource allocation device.

For example, when the number of data transmission devices that receive the use authorization from the resource allocation device is relatively great, the resource allocation device may set a use authorization for a contention time period to a relatively high value, and may allow a data transmission device having a relatively high order of priority to use the contention time period.

In operation 830, the resource allocation device may transmit the use authorization for the contention time period to a plurality of data transmission devices.

According to an embodiment of the present invention, each data transmission device may set an order of priority for a contention time period. According to another embodiment of the present invention, the resource allocation device may set an order of priority of each data transmission device, and may transmit the set order of priority to each data transmission device.

According to still another embodiment of the present invention, the order of priority of each data transmission device may be set based on a characteristic of data to be transmitted by each data transmission device. The data transmission device may set a relatively high order of priority when data to be transmitted is responsive to a time delay, and may set a relatively low order of priority when data to be transmitted is non-responsive to a time delay. As the data sensitive to a time delay, audio data may be given.

Each data transmission device may compare an order of priority for each data transmission device and the use authorization for a received contention time period, and may determine whether to use the contention time period based on a result of the determination.

For example, the data transmission device may determine to transmit data using the contention time period when the order of priority for the contention time period is greater than or equal to the use authorization for the contention time period.

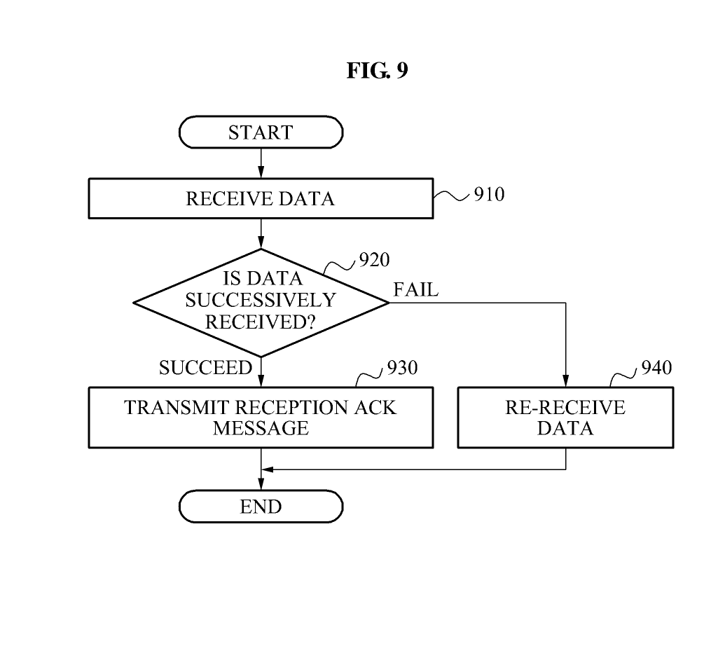

FIG. 9 is a flowchart illustrating a method of receiving data according to embodiments of the present invention.

A data transmission device may compare an order of priority set for a contention time period to an order of priority of the data transmission device, and may transmit data to a data reception device during the contention time period based on a result of the comparison. For example, the data transmission device may determine to use the contention time period when the order of priority of the data transmission device is greater than or equal to the use authorization for the contention time period, and may transmit data during the contention time period.

In operation 910, the data reception device may receive data from the data transmission device. According to an embodiment of the present invention, the order of priority of the data transmission device may be set based on a characteristic of data transmitted by the data transmission device. When data transmitted by the data transmission device is responsive to a time delay, for example, when the data corresponds to audio data, the order of priority of the data transmission device may be set to a relatively high value.

According to another embodiment of the present invention, each data transmission device may wait for a predetermined period of time from a starting time of the contention time period. When each data transmission device does not receive data from another data transmission device during the predetermined period of time, each data transmission device may determine that another data transmission device fails to transmit data during the contention time period. In this instance, a data transmission device may transmit data to the data reception device.

In operation 920, the data reception device may determine whether the data reception device succeeds in receiving data. For example, when a single data transmission device transmits data in operation 910, the data reception device may succeed in receiving data. In this instance, in operation 930, the data reception device may transmit a reception ACK message for the received data to the data transmission device.

However, when a plurality of data transmission devices transmits data in operation 910, data transmitted by the plurality of data transmission devices may collide and thus, the data reception device may not succeed in receiving data.

When the data reception device does not succeed in receiving data, it may re-receive data in operation 940.

Operation 940 may be performed in a manner similar to operation 910. When the data reception device receives data from a plurality of data transmission devices in operation 910, the data reception device may re-receive data in operation 940.

In operation 940, after a predetermined period of time from a starting time of the contention time period for re-receiving data, the data reception device may re-receive the data transmitted in operation 910 by one of a plurality of data transmission devices from another one of the plurality of data transmission devices among the plurality of data transmission devices.

The above-described exemplary embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of transmitting data, the method comprising:
setting an order of priority for a contention time period;
receiving, from a resource allocation device, a use authorization for the contention time period;
determining whether to use the contention time period by comparing the order of priority and the use authorization; and
transmitting data to a data reception device during the contention time period based on the determination.

2. The method of claim 1, wherein the order of priority is set based on a characteristic of the data.

3. The method of claim 2, wherein, when the data corresponds to audio data, the order of priority is set to a relatively high value.

4. The method of claim 1, further comprising:
receiving, from the resource allocation device, an order of priority for the contention time period,
wherein the setting comprises setting an order of priority for the contention time period according to the received order of priority.

5. The method of claim 1, further comprising:
determining whether a reception acknowledgement (ACK) message is received for the transmitted data, and
retransmitting the data when the reception ACK message is not received.

6. The method of claim 1, wherein the determining comprises determining to use the contention time period when the order of priority is greater than or equal to the use authorization.

7. The method of claim 1, further comprising:
waiting during a predetermined period of time from a starting time of the contention time period; and
cancelling the transmitting of data when second data transmitted by a data transmission device is received during the predetermined period of time.

8. A method of allocating a resource, the method comprising:
determining a contention time period;
setting a use authorization for the determined contention time period; and
transmitting the use authorization to a plurality of data transmission devices in which an order of priority for the contention time period is set,
wherein the use authorization is compared to the order of priority of each of the plurality of data transmission devices, and the plurality of data transmission devices transmits data to a data reception terminal during the contention time period based on a result of the comparison.

9. The method of claim 8, wherein the order of priority of each of the plurality of data transmission devices is set based on a characteristic of the data.

10. The method of claim 9, wherein, when the data corresponds to audio data, the order of priority of each of the plurality of data transmission devices is set to a relatively high value.

11. The method of claim 8, further comprising:
setting an order of priority for the contention time period of each of the plurality of data transmission devices; and
transmitting the set order of priority to each of the plurality of data transmission devices.

12. The method of claim 8, wherein the plurality of data transmission devices transmits the data when the order of priority is greater than or equal to the use authorization.

13. A method of receiving data, the method comprising:
comparing a use authorization set for a contention time period and an order of priority set for a data transmission device; and
receiving transmitted data according to a result of the comparison from the data transmission device during the contention time period.

14. The method of claim 13, wherein the order of priority is set based on a characteristic of the data.

15. The method of claim 14, wherein, when the data corresponds to audio data, the order of priority is set to a relatively high value.

16. The method of claim 13, further comprising:
transmitting a reception acknowledgement (ACK) message for the received data to the data transmission device.

17. The method of claim 13, wherein the contention time period is determined to be used when the order of priority is greater than or equal to the use authorization.

18. The method of claim 13, further comprising:
re-receiving, after a predetermined period of time, from one of a plurality of data transmission devices, data transmitted by the one of the plurality of data transmission devices,
wherein the receiving of data comprises receiving data from each of the plurality of data transmission devices.
